(19) United States
(12) Patent Application Publication
(10) Pub. No.: US 2017/0019689 A1
(43) Pub. Date: Jan. 19, 2017

(54) Broadcast signal convertion and insertion to cable convertor box

(71) Applicant: Tariq Ahmad, Reno, NV (US)

(72) Inventor: Tariq Ahmad, Reno, NV (US)

(21) Appl. No.: 14/757,291

(22) Filed: Feb. 19, 2014

(51) Int. Cl. H04N 21/2343; H04N 21/2347; H04N 21/61

(52) U.S. Cl. CPC H04N 21/2343; H04N 21/6112; H04N 21/6125; H04N 21/6162; H04N 21/6175; H04N 21/2347

(57) ABSTRACT

Cable Television Operators (CTO) receives broadcast signals that are transmitted over the air under the Advanced Television System Committee (ATSC) standard in the form of 8VSB signals in digital format. The CTO converts, encrypts, and compresses the signals to either analog or QAM, IP, or other digital signal standards (QAM*), and transmits these signals through the cable plant or streaming video services to their customers. The QAM* signals lose video quality when they are encrypted and compressed to be sent through the cable plant or streamed. The local channels are broadcasted as digital off-air signals and are intercepted in the form of 8VSB signals. These 8VSB signals are converted into clear QAM* signal shown in FIG. 1. The clear QAM* signals have a higher video quality due to no encryption and compression. The clear and encrypted QAM* signals are combined and inserted into the video providers equipment (DVR, etc.) at the customer's premises shown in FIG. 2. Customers are allowed to use existing interface and channel guide with the subscribed network in addition to the off-air digital signals.

### BACKGROUND OF THE INVENTION

1. Technical Field

This invention relates to Multi Channel Video Distributors, 8VSB broadcast signals, and clear QAM signals.

2. Background of the Related Art

Currently Multi Channel Video Distributors (MVPD), such as Cable Television Operators (CTO), receives broadcast signals which are transmitted over-the-air under the Advanced Television Systems Committee (ATSC) standard. The ATSC standards for over-the-air broadcast signals are 8VSB, which is in a digital format. The CTO then converts the signals to either Analog (RF) or Quadrature Amplified Modulation (QAM), and transmits these signals through the Cable Plant to their customers.

Cable companies encrypt and compress the signals via QAM modulation (before it is received by the customer), and is decoded with the customer's premise equipment (which can consist of Digital Video Recorder (DVR), Set Top Box, or other video provider equipment).

Using the existing model described above, CTO's have to receive retransmission consent from the owner of the broadcast signals. This involves a payment by the CTO to pay the broadcast signal owner on a per subscriber basis.

### PREVIOUS EXAMPLES

Previously local channels were received off-air at customer premise, and inserted into the television through the RF input or other means. In order to view local channels, the customer had to physically change the inputs on the TV. By switching inputs on the TV for the local channels, the coexisting interface and channel guide provided by the CTO would not work.

Our invention allows the insertion of the broadcast signals at customer premise and will work seamlessly with the CTO's channel guide.

Copyright laws allow customers to view broadcast channels without violating Copyright laws, however when the broadcast signals are transmitted through a central location such as a Cable Company Head End or Central Antenna System, Copyright Laws still apply (See American Broadcasting Companies, Inc., vs. Acrco Inc. Supreme Court No. 13-416).

Copyright laws would not apply to our invention, as broadcast signals are inserted at customers premise.

### SUMMARY OF THE INVENTION

This invention utilizes the current broadcast signals (ATSC with 8VSB) and converts the signals using RT3550-13a, to clear (not encrypted) QAM, IP, streaming, or other signals standards (QAM*).

The invention receives the 8VSB signals at the customer premise and converts the signals to QAM*. The QAM* signals are inserted using an RF, HDMI, or composite video outputs. The combined output signals of RT3550-13a and the CTO's signals are inserted into the customer premise equipment.

Cable Operators no longer have to distribute the off-air broadcast signals through the cable plant and therefore do not require a retransmission consent agreement. The CTO will leave the frequency empty for the off-air broadcast signals, thus when R13550-13a is combined with the cable television or other video provider equipment, via a signal combiner (RF splitter or HDMI splitter) the existing interface and channel guide will work seamlessly.

The purpose of this invention is to allow the CTO to stop sending the local channels signal through the network. With the implantation of this invention it doesn't affect the coexisting interface and channel guide, which is broadcasted through the network. The benefits of using this invention is that it is able to capture the 8VSB signals and convert it into clear QAM* signals. By doing this at the customers premise the quality of the signals are not degraded through the cable plant.

The signal quality that the customer receives through RT3550-13a is much higher, than the current quality that is through the network. Reasons for the lower quality signals are due to the CTO compressing and encrypting the QAM modulation, which is sent through the cable plant.

QAM*-QAM, IP, streaming, or other signal standards.

### BRIEF DESCRIPTION OF THE DRAWINGS

FIG. 1 is a flow diagram showing RT3550-13a Conversion Process of 8VSB to clear QAM* signals.

FIG. 2 is a flow diagram showing the broadcast signals conversion and insertion into the cable box.

QAM*-QAM, IP, streaming, or other signal standards

### DETAILED DESCRIPTION

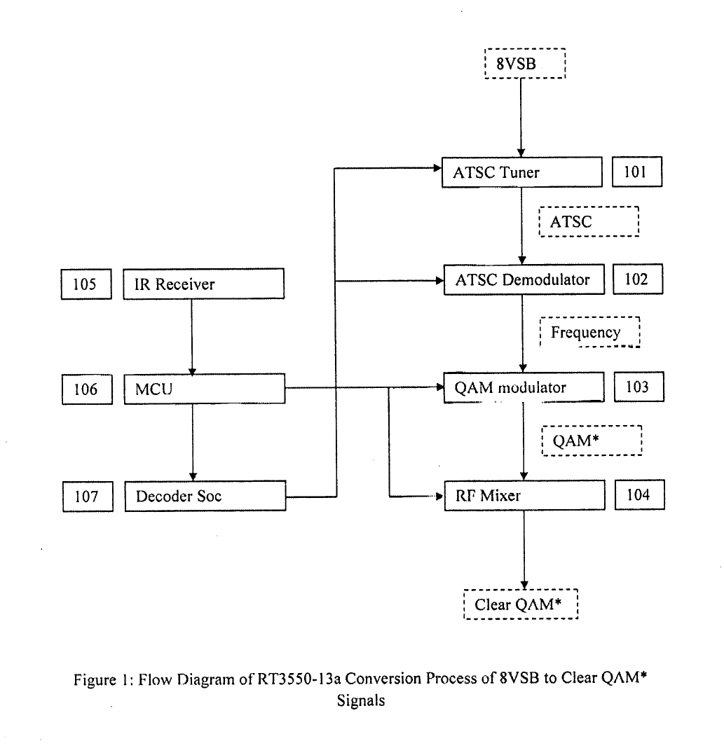

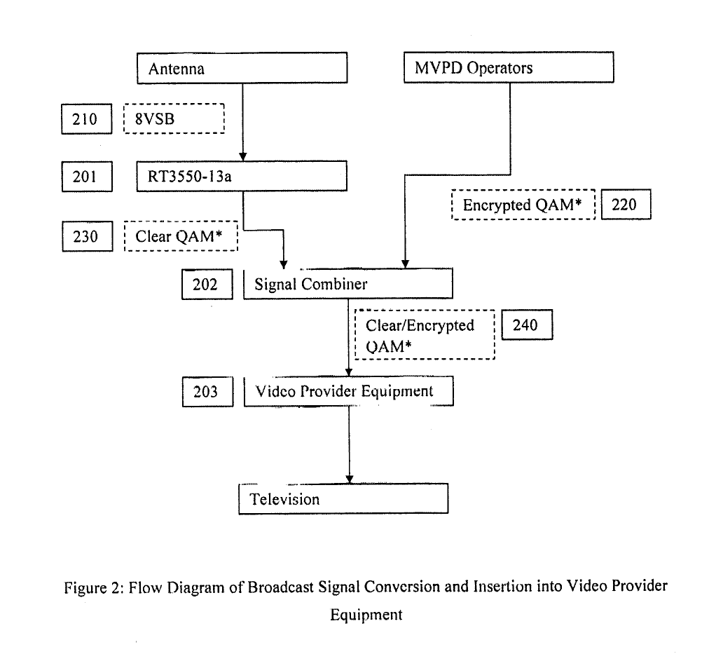

Embodiments for this invention are described with references to flow diagrams. FIG. 1 describes the procedure of converting the 8VSB signals into QAM8 thru RT3550-13a. FIG. 2 is a broadcast signal conversion and insertion into video provider equipment.

FIG. 1 is a flow diagram of RT3500-13a that receives the 8VS signals at the customers premise with the use of an antenna, and converts the signals into QAM* signals.

101 is a tuner, which receives the 8VS signals and converts them into ATSC signals.

102 is a demodulator, which takes the newly formed ATSC signals and converts into frequencies.

103 is a modulator, which takes generated frequencies and transforms them into clear QAM* signals.

104 is a RF mixer, which takes the clear QAM* signals, designated and channel maps them into the clear QAM* signals for the purpose of working seamlessly with video provider equipment.

105 is an Infrared (IR) receiver, which receives signals from the remote for desired channel selection.

106 is a Microcontroller Unit (MCU), which converts the IR receiver signals into frequencies. These newly obtained frequencies are then sent to 103 and 104 to be channel mapped and modulated into clear QAM* signals. The frequencies are also sent to 107 to be decoded.

107 is a decoder, which takes the frequencies from the MCU and designates a channel to them. The designated channel frequencies are then sent to 101 and 102 to be tuned to ATSC signals.

FIG. 2 is a flow diagram that describes the whole process of the invention, which utilizes the current broadcast signals of 8VSB (that applies with the ATSC standards) and converts the signal to a clear QAM* signals using RT3550-13a. The clear QAM* is combined with the encrypted QAM* signals are combined and inserted into the video providers equipment at the customers premise.

210 are 8VSB signals being received from an antenna and sent into RT3550-13a.

201 is the process of the RT3550-13a is shown in FIG. 1 and is described above (101 thru 107).

220 are encrypted QAM* signals that are sent by the CTO and received by the customer, that provide the customer with the interface, channel guide, and subscribed channels.

230 are clear QAM* signals that are produced from RT3550-13a.

202 is a combiner, which takes the clear QAM* signals from RT3550-13a shown in FIG. 1, and combines them with the encrypted QAM* signals provided by the CTO.

240 are the combination of the clear and encrypted QAM* signals.

203 is the video provider equipment (DVR, Set Top Box, or other video streaming devices), that receive the combined QAM* signals (encrypted from CTO and clear QAM* from RT3550-13a). The video provider equipment translates the encrypted QAM* signals allowing customers to use their existing interface, channel guide, and subscribed channels. While simultaneously using the clear QAM* signals that provide broadcast channels.

QAM*-QAM, IP, streaming, or other signal standards.

1. Multi Channel Video Distributors (MVPD) operators commonly known as Cable Television Operators (CTO), retransmit compressed and encrypted QAM broadcast signals through the network, thus having to receive retransmission consent.

2. The invention according to claim 1, allows the CTO to only send QAM, IP, streaming, or other signal standards (QAM*) signals which have retransmission consent. Leaving the blank channels for off-air broadcast signals.

3. The invention according to claim 1, has a much higher QAM* signal quality, than the current quality from the CTO due to them compressing and encrypting the QAM* modulation that is sent through the cable plant.

4. This invention utilizes the current broadcast signals (ATSC with 8VSB) and converts the signals into clear (not encrypted) QAM* signals.

5. The invention according to claim 4, inserts clear QAM* signals into video provide equipment (DVR, Set Top Box, or other video streaming devices) allows the customer to watch off-air broadcast signals.

6. The invention according to claim 4, by the customer inserting the clear QAM* signals into video provider equipment at the customers premise it does not violate any Copyright Laws.

7. The invention according to claims 1 and 4, allows the insertion of the clear QAM* signals into video provider equipment allowing the customer to watch off-air broadcast signals (local channels) and subscribed network (cable network) without switching inputs on the television.

8. The invention according to claims 1 and 4, allows insertion of the clear QAM* signals into video provider equipment allowing the customer to watch off-air broadcast signals (local channels) and subscribed network (cable network) utilizing the existing interface and channel guide.

9. The invention according to claim 8 has a channel lineup of the off-air broadcast signals.
